(19) United States
(12) Patent Application Publication
(10) Pub. No.: US 2026/0008397 A1
(43) Pub. Date: Jan. 8, 2026

(54) TABLE WITH MOVABLE GUIDE ELEMENT

(71) Applicant: Seisenbacher GmbH, Ybbsitz (AT)

(72) Inventors: Lorenz Burggraf, Katsdorf (AT); Jakob Anger, Waidhofen/Ybbs (AT)

(21) Appl. No.: 18/881,571

(22) PCT Filed: Jul. 5, 2023
(86) PCT No.: PCT/AT2023/060216

§ 371 Date: Jan. 6, 2025

(30) Foreign Application Priority Data
Jul. 7, 2022 (AT) A 50498/2022

(51) Int. Cl. B60N 3/00

(52) U.S. Cl. CPC B60N 3/002

(57) ABSTRACT

The invention relates to a table for a vehicle, wherein the table has at least one base for attachment to the vehicle, and comprises a tabletop connected to the base, and wherein the tabletop can be moved in relation to the base along a transverse axis of the table transverse to a longitudinal axis of the table, wherein the tabletop and the base are connected to one another via at least two connection systems and wherein each connection system comprises a guided connection between tabletop and base via two mutually interacting guide elements, wherein the guide elements are designed such that, during a movement along the transverse axis, a force transfer takes place between these guide elements, characterised in that for each connection system a first guide element is connected to the tabletop such that it is immovable along the transverse axis, and a second guide element is connected to the base such that it is immovable along the transverse axis, and in that at least one guide element of at least one connection system is connected to the element to which it is connected such that it is immovable along the transverse axis such that it is movable along the longitudinal axis.

The invention relates to a table for a vehicle, wherein the table has at least one base for attachment to the vehicle and a tabletop connected to the base, and wherein the tabletop can be moved in relation to the base along a transverse axis of the table transversely to a longitudinal axis of the table, wherein the tabletop and the base are connected to one another via at least two connection systems and wherein each connection system comprises a guided connection between the tabletop and the base via two mutually interacting guide elements, wherein the guide elements are designed in such a way that, during a movement along the transverse axis, a force transfer takes place between these guide elements.

In vehicles, especially rail vehicles, it is common for passengers to be seated at tables, which are normally assigned a total of four seats or standing places. As a rule, two seats are arranged next to each other in the direction of travel and two opposite seats are arranged against the direction of travel with the table between them. Accordingly, the longitudinal axis of the table is usually aligned transversely to the direction of travel of the vehicle.

The direction of travel refers to the main direction of travel of the vehicle, in which the vehicle generally moves. In the vast majority of cases, the direction of travel is parallel to the longitudinal axis of the vehicle.

To protect passengers sitting on the seats facing the direction of travel, the table can have an energy absorption mechanism. In the event of strong acceleration, for example in the event of emergency braking or a collision, the kinetic energy of the passengers impacting on the table is at least partially absorbed and their risk of injury is reduced.

EP 2 956 347 B1 describes a table with plastically deformable connecting elements that deform plastically in the event of an impact and thus absorb energy. However, this is disadvantageous because after such an incident, essential parts of the table have to be replaced in order to make it functional again. The work involved is time-consuming and expensive.

US 2012/0132767 A1 shows an improved system that has elastically movable connecting arms and rods that extend vertically from the base to the tabletop. This prevents the parts from being destroyed in the event of emergency braking. In addition, the risk of injury is further reduced. A disadvantage, however, is that passengers' body parts can be crushed as the height of the tabletop changes during movement.

WO 2021/001103 A1 discloses a table which connects the base to the tabletop via an intermediate element with a cantilever arm underneath the tabletop. This intermediate element is movable relative to the tabletop via slotted hole-pin connections and with the base via further slotted hole-pin connections. This enables rotation along two different axes of rotation, depending on the impact point of the passenger or passengers. However, this design is very complex and cost-intensive. In addition, only a limited range of movement is provided, as the slotted pin connections have to be arranged in a limited space.

It is therefore the object to provide a table of the type mentioned, which has a reduced risk of injury to passengers in the event of strong acceleration and can be manufactured as simply and inexpensively as possible.

This object is solved in accordance with the invention in that for each connection system a first guide element is immovably connected to the tabletop along the transverse axis, and a second guide element is immovably connected to the base along the transverse axis, and in that at least one guide element of at least one connection system is movably connected along the longitudinal axis to the element to which it is immovably connected along the transverse axis.

The fact that at least one connecting element is movable along the longitudinal axis compensates for a change in the distance or alignment of the connection systems or their parts in relation to each other caused by rotation of the tabletop. This ensures that the tabletop can rotate or move linearly in various ways in relation to the base, and therefore also in relation to the vehicle itself. The rotation is not limited to one or two pivot points, but the pivot point can be located at completely different points, even outside the tabletop, depending on the distribution of the applied force. This embodiment is very simple and inexpensive to manufacture, but at the same time very safe and reliable in its function.

In addition, this embodiment can achieve a particularly wide range of movement for the tabletop, as the two connection systems can also be further apart. This provides a particularly large path along which the tabletop can move in the event of an impact and the energy can be absorbed. This reduces the necessary momentary deceleration of the passenger, which reduces the risk of injury and offers a particularly safe design.

It may be provided that both guide elements of a connection system are movable along the longitudinal axis, while the others are not movable along the longitudinal axis. It may also be provided that one or a different number of guide elements of each connection system are movable along the longitudinal axis.

Movable or mobile means that the tabletop can be moved relative to the base if a sufficiently large force, for example a force above a certain threshold value, is exerted on the tabletop essentially in the direction of travel. For example, this can be the force exerted on the table by a passenger when they are pressed against the table by a collision or emergency braking of the vehicle.

The guide element should therefore be moved at least as far along the longitudinal axis and allow the tabletop to rotate in relation to the base to such an extent that sufficient energy can be absorbed by a passenger who collides with the table alone. This mobility can be achieved, for example, by a displaceability along the longitudinal axis, preferably in the range of a few millimeters, particularly preferably at least 5 mm, very particularly preferably at least 10 mm or very particularly preferably at least 15 mm.

Concerning “with the element to which the respective guide element is immovably connected along the transverse axis”, “element” means either the tabletop or the base, depending on which of these components the respective guide element is immovably connected to.

The term “immovably connected” means that the connection does not allow any significant relative movement along the longitudinal axis. There may be a small amount of play between the two components, but this only allows insignificant movement.

Force transfer means that at least one of the connecting elements absorbs energy during the movement. This can occur, for example, through friction, plastic or elastic deformation. As one connecting element is immovably connected to the tabletop and one to the base along the transverse axis, a collision and impact of a person or object and the resulting movement of the tabletop will cause the connecting elements to move in relation to each other. By absorbing the energy, the movement of the tabletop and the body impacting on it is reduced, thus lowering the risk of injury.

Directional or orientation information such as above or horizontal refers to an intended installation position of the table in a vehicle.

It is preferably provided that the force transfer between the guide elements comprises a plastic deformation of at least one of these parts and/or friction between the guide elements. In this way, energy can be absorbed very effectively along the movement of the tabletop and the passenger can be decelerated. It may be provided that force transmission only occurs in a partial area of the range of movement of the connecting elements relative to one another and/or that plastic deformation or friction only occurs in a partial area.

Furthermore, it is advantageous if a guide element of at least one connection system, preferably of all connection systems, is designed as a slotted hole, which preferably has a smaller width, at least in sections, than the guide element guided by it, and that the other guide element is designed as a pin, which is arranged in the slotted hole and is guided thereby. It may be provided that all slotted holes are arranged on one element, for example the tabletop (i.e. immovably connected along the transverse axis), or that at least one slotted hole is immovably connected to the tabletop and at least one slotted hole is immovably connected to the base along the transverse axis. A slotted hole is an essentially elongated opening that guides the pin through its side walls along its longitudinal extension and limits its movement transverse to the longitudinal extension. The pin can be a cylindrical element, for example, but it can also have any other shape such as a cuboid.

The slotted hole can be linear or at least curved in sections.

Due to the smaller width of the slotted hole than the other guide element that is guided in it, this guide element is inhibited in its movement along the slotted hole. Depending on the widths, movement towards each other can be made possible by friction or by plastic deformation of the slotted hole and/or the other guide element. This means that a certain minimum force must be exerted on the tabletop in order to achieve movement of the guide elements in relation to each other.

The mobility along the longitudinal axis with simultaneous immobility along the transverse axis of the guide element in relation to the element on which it is arranged can also be achieved in different ways. For example, the guide element can be guided in slotted holes in the tabletop or the base, which allow movement along the longitudinal axis and prevent movement along the transverse axis. Alternatively, it can be provided that the guide element is fixed along the transverse axis by retaining pieces of the element. For example, the tabletop or the base can have a frame that limits the guide element along the transverse axis. If it remains free along the longitudinal axis or has play, movement along the longitudinal axis can be ensured.

It may be provided that the slotted hole has a receiving region with an enlarged cross-section, in which the pin is arranged in an initial position of the tabletop relative to the base, wherein the cross-section of the receiving region is adapted to the shape and size of the pin and/or preferably the receiving region is arranged substantially centrally along a longitudinal extension of the slotted hole. In this way, the tabletop is fixed in its initial position, generally the position that the tabletop is to assume during its use as a table surface in the vehicle, and is limited in its movement relative to the base to such an extent that displacement only occurs if a sufficiently high force is exerted, for example by a collision. In addition, the tabletop can simply be inserted into the receiving region during assembly.

If it is provided that the slotted hole tapers in at least one direction, at least in sections, from a receiving region in which the pin is arranged in an initial position of the tabletop opposite the base, the energy absorption can be changed during the movement along the slotted hole. It can be adjusted so that initially little and then increasingly more energy is required to move the guide elements further towards each other. It may be provided that the slotted hole widens from the receiving region in at least one direction, at least in sections. Steps or various surface structures such as teeth or waves can also be provided. These designs of the slotted hole allow the energy absorption to be adjusted during the path of the tabletop.

It may also be provided that the slotted hole widens in at least one direction, at least in sections, from a receiving region in which the pin is arranged in an initial position of the tabletop relative to the base. The width of the slotted hole therefore increases in at least one direction from the receiving region. It has been shown that parameters can change in relation to each other along the path traveled by the guide elements, thereby increasing the counteracting force. By widening the slotted hole along the path, this can be compensated for and a uniform energy absorption along the path can still be achieved.

It is preferably provided that the connection systems are arranged along the longitudinal axis of the table and/or the slotted hole of at least one connection system preferably extends along the transverse axis. By arranging them along the longitudinal axis, the space under the tabletop can be optimally utilized and unfavorable force application to the tabletop can be prevented. By extending the slotted hole along the transverse axis, energy is optimally absorbed and the tabletop is guided when a passenger hits the tabletop along the transverse axis.

It is particularly advantageous if the slotted hole of at least one connection system is arranged in a guide plate and if preferably the guide plate of at least one, particularly preferably all connection systems, is either immovably connected to the base along the transverse axis and movably connected along the longitudinal axis or is immovably connected to the tabletop along the transverse axis and movably connected along the longitudinal axis. The width of the gap, i.e. the slotted hole, in the guide plate means that the force can be defined as required over the path in the event of a load. A narrower gap leads to a greater force due to friction and/or plastic deformation and, conversely, the force can be reduced by a wider gap, down to zero if the gap in the plate is wider than the pin. In addition to the difference in width between the slotted hole and the other guide element, the thickness of the guide plate can be used to adjust how much energy is required for movement. The thickness of the plate can also be used to vary the proportion of energy absorbed by friction and plastic deformation. With a thick plate, there is hardly any plastic deformation and therefore a high proportion of friction. The guide plate can be made of sheet metal. The slotted hole can be made by laser cutting, for example. If more than one slotted hole is provided, it is preferable that at least one slotted hole is arranged on a different guide plate than another slotted hole.

The arrangement is particularly advantageous as the force and energy can be freely adjusted along the path and the elements can be manufactured very cost-effectively (e.g. by laser cutting). Furthermore, the energy-absorbing mechanism can be implemented very compactly and involves only a few components. It is therefore a system that is very easy to replace. Installation is possible underneath the tabletop, but also inside the tabletop due to its compactness.

Furthermore, it may be provided that the guide plate has several layers and the slotted hole in at least one layer has a different cross-section, at least in sections, than the slotted hole of another layer and/or the slotted hole in at least one layer projects at least in sections beyond the slotted hole of another layer. In this way, the energy absorption can be further adjusted. The layers can be made of different materials. For example, at least one layer can perform the plastic deformation. By replacing only this layer, the function of the table can be restored after a collision.

It may also be provided that the guide plate is designed in several pieces in a plane parallel to the tabletop, with the pieces preferably overlapping. In other words, the tabletop therefore has several partial plates which are arranged offset to one another in projection to the tabletop and preferably overlap. For example, one part of at least one slotted hole can be formed by one partial plate and at least one other part by at least one other partial plate. Such embodiments are particularly resistant to bending, which prevents evasive movements of areas of the guide plate, which can occur under certain circumstances due to the high forces in the event of a collision. Supporting the moment around the axis transverse to the direction of travel may be necessary to give the table sufficient stability and thus prevent a change in the height of the tabletop (minimizing the risk of injury). In order to prevent the tabletop from tilting, it may be provided that the tabletop is connected to the base via a stabilizing connection, wherein the stabilizing connection limits the movement of the tabletop in relation to the base to a plane which is spanned by the longitudinal axis and transverse axis. In this way, the base area below the tabletop can be made as narrow as possible and the greatest possible space for the tabletop to move can be provided without the tabletop tilting when an unfavorable force is applied.

It is particularly advantageous if the stabilizing connection comprises a beam firmly connected to the tabletop at least in a vertical axis transverse to the longitudinal axis and to the transverse axis and if the beam is guided in an opening in the base which prevents the beam from pivoting about the longitudinal axis. The opening limits the beam in the direction of the vertical axis so that it cannot be moved along the vertical axis, optionally with slight play. Preferably, it does not limit the movement of the tabletop along the longitudinal or transverse axis.

Furthermore, it may be provided that the connecting device has at least one elastically deformable secondary element, which is connected between the tabletop and the base and is preferably arranged in the beam. This secondary element can at least partially support the connection systems in absorbing the energy in the event of an impact, and/or cause the tabletop to at least partially return to its original position after a movement along the transverse axis.

It may be provided to reset the tabletop that the elastically deformable secondary element can be used to pretension the tabletop to an initial position in relation to the base.

Furthermore, it may be provided that the table has a substructure firmly connected to the base, and that the substructure preferably has at least one table leg which can be connected to a vehicle floor. The substructure can serve to mechanically fasten the tabletop and dissipate the forces along the vertical axis caused by objects placed on the tabletop. The substructure can have a cantilever arm that extends under the tabletop or in the tabletop along the longitudinal axis. It is particularly advantageous if the base is firmly connected to a substructure extending essentially along the longitudinal axis and the tabletop is arranged on the substructure so that it can move. The substructure can be designed in such a way that the connecting elements can be arranged at least partially therein, protected from unauthorized manipulation. The tabletop can be movably arranged on the substructure and rest on it. The substructure and the base can also be designed in one piece. Preferably, the substructure is less wide transversely to the longitudinal axis than the tabletop. This allows the tabletop to move transversely to the longitudinal direction, even if it protrudes at least partially beyond the substructure at its side edges.

It may be provided that the substructure has at least one table leg that can be connected to a vehicle floor. This enables a particularly good connection to the vehicle. Depending on the length of the leg, the table can be attached at different heights.

It is particularly advantageous if the base can be connected to a vehicle wall of the vehicle. Lateral attachment to a side wall of the vehicle is particularly advantageous.

In the following, the present invention is explained in more detail with reference to the non-limiting embodiment variants shown in the figures, wherein:

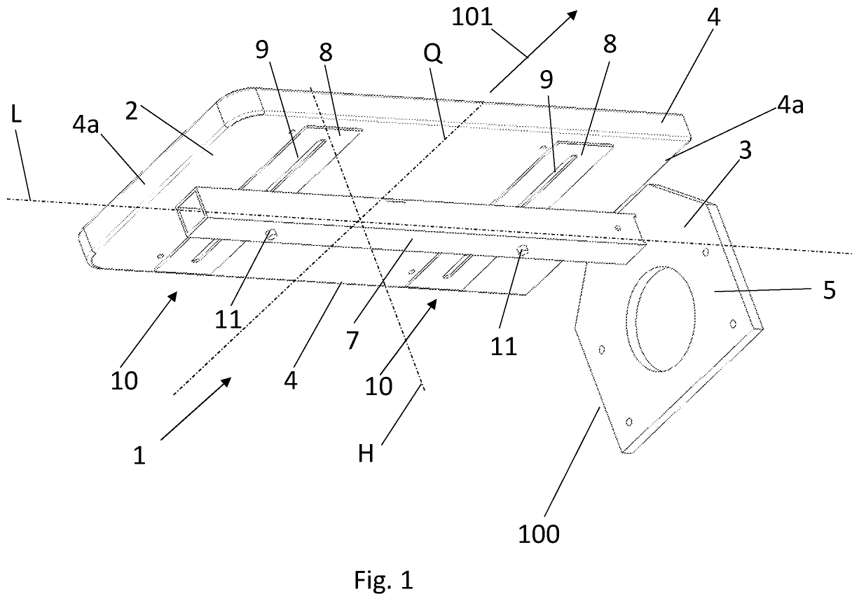

FIG. 1 shows a first embodiment of a table according to the invention in a view from diagonally below in an installation position in a vehicle;

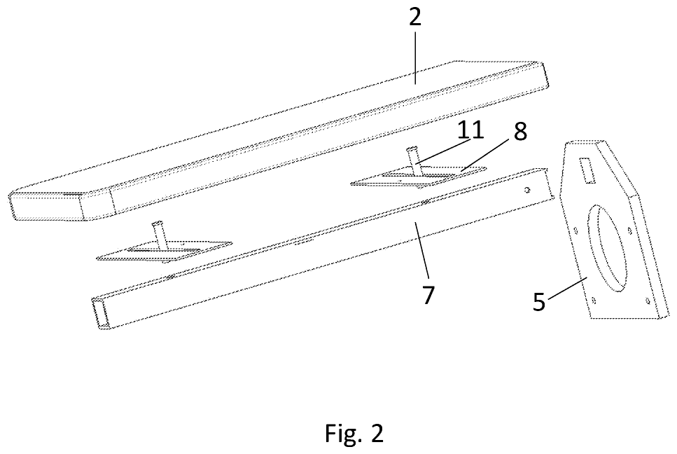

FIG. 2 shows an exploded view of the embodiment shown in FIG. 1;

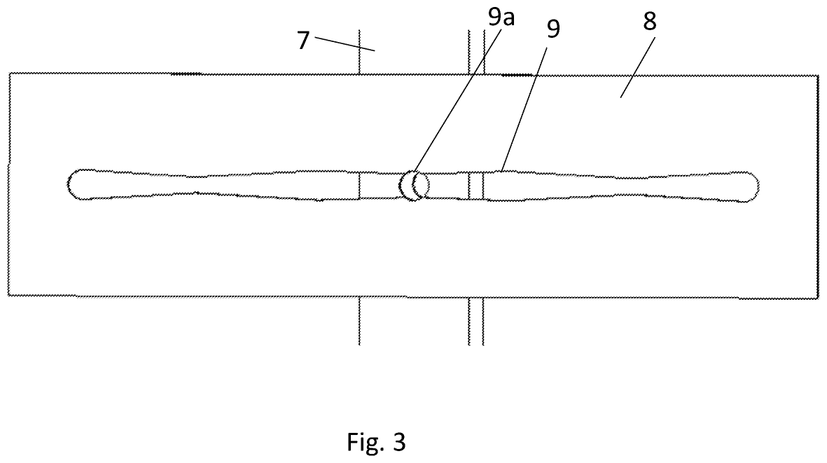

FIG. 3 shows a detailed view of an alternative guide plate on the base of the first embodiment in a plan view;

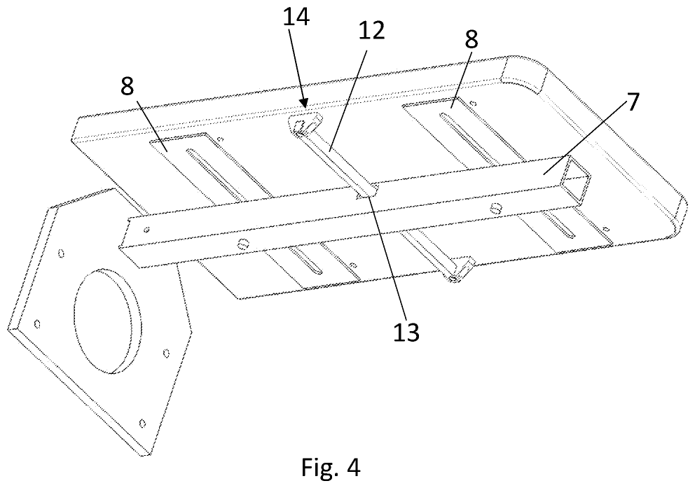

FIG. 4 shows a second embodiment of a table according to the invention in a view from diagonally below;

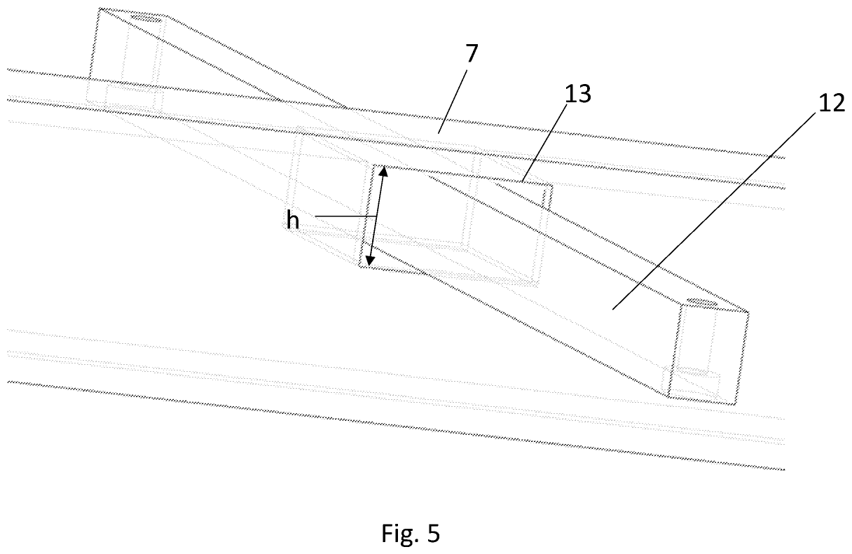

FIG. 5 shows a detailed view of the base and the beam in an oblique view.

FIG. 1 and FIG. 2 show a table 1 according to the invention with an essentially rectangular tabletop 2 and a base 3. The table 1 can be connected to a wall 100 of a vehicle via a wall part 5 of the base. The rest of the vehicle is not shown for the sake of clarity. A longitudinal axis L of the table 1 extends parallel to the longer side edges 4 of the tabletop 2 and lies transverse to a direction of travel 101 of the vehicle. A transverse axis A lies transverse to the longitudinal axis and parallel to the direction of travel 101 and to the shorter side edges 4a of the tabletop and the vehicle wall 100. The base 3 has a substantially vertical wall part 5 that rests against the vehicle side wall 100 and a substructure 7 directly below the tabletop 2. The substructure 7 has a cantilever arm which extends away from the wall part 5 along the longitudinal axis L. In FIG. 1, the tabletop 2 is shown in an initial position in which it remains when the table 1 is used as intended. Even minor manipulations such as lightly pressing on or supporting the tabletop do not cause the tabletop 2 to move relative to the base 3; a corresponding movement only occurs in the event of a collision and the application of large forces.

Two guide plates 8 are arranged on the underside of the tabletop 2 along the longitudinal axis L, each of which has a slotted hole 9 extending along the transverse axis Q. The guide plates 8 are connected to the tabletop 2 in such a way that they are immovable relative to it along the transverse axis Q. In this embodiment, the slotted holes 9 thus represent the first guide elements. The guide plate 8, which is further away from the wall part 5, is movable along the longitudinal axis L in relation to the tabletop 2. This can be achieved, for example, by connecting these guide plates 8 and the tabletop 2 via screw connections or other connecting elements, wherein the connecting elements of the guide plate 8 movable along the longitudinal axis L are connected via slotted holes. These slotted holes preferably extend along the longitudinal axis L. Alternatively or additionally, it may be provided that the pin 11 of at least one connection system 10 is movable along the longitudinal axis L in relation to the base 3. Preferably, it can be provided that this is made possible by a bearing in a slotted hole.

Connected immovably to the base 3 in the longitudinal direction L and in the transverse direction Q are pins 11, which in this embodiment are inserted into holes in the cantilever arm. These pins 11 therefore represent the second guide elements in this embodiment. They engage in the slotted holes 9 of the guide plates 8 and thus create a connection between the tabletop 2 and the base 3.

In the embodiment shown, the slotted holes 9 are holes of elongated design which have a uniform width along their longitudinal extension along the transverse axis Q. Preferably, the slotted holes 9 are substantially parallel to each other, in this and any other embodiment.

The width of the slotted holes 9 is slightly smaller than the diameter of the pin 11. In the event of a collision, people sitting in the direction of travel are pressed against the tabletop 2 and exert a force on it. In the event of a collision, this force is great enough to push the pin 11 along the slotted holes 9, wherein energy is absorbed by friction between these components and the slotted holes and/or the pin are also plastically deformed.

If the tabletop 2 is loaded unevenly, for example if only one person at the end of the table 1 facing away from the wall part 5 hits the tabletop 2, the pins 11 move unevenly along the slotted holes 9 and the tabletop 2 pivots. Tilting and blocking of the pins 11 in the slotted holes 9 is avoided by the fact that a guide plate 8 can move slightly along the longitudinal axis L, thus compensating for the different direction of movement of the pins 11 in relation to the longitudinal extent of the slotted holes 9.

FIG. 3 shows an alternative embodiment of a guide plate 8, which can be used in tables according to the invention like those in the other figures. The tabletop 2 and the pin 11 are not shown. The slotted hole 9 has a receiving region 9a which is wider than the adjacent areas of the slotted hole 9. The receiving region 9a is arranged centrally along the longitudinal extension of the slotted hole 9. This allows the tabletop 2 to be moved in both directions along the transverse axis Q, which enables the table 1 to absorb energy in the event of a collision even when the direction of travel is reversed.

The slotted hole 9 is substantially symmetrical in design, wherein it first has a section with a constant width from the receiving region 9a, followed by an area with a tapering width, followed by an area with a widening width. Such a design means that after exceeding the minimum force for movement from the receiving region 9a, a constant force is initially required for further movement, this force then increases and then decreases again. This results in an advantageous energy absorption behavior along the path of the tabletop 2 in the event of a collision.

FIGS. 4 and 5 show an alternative embodiment which is similar to that shown in FIGS. 1 and 2. For this reason, only the most important differences are described here; components with the same effect are marked with the same reference signs.

A stabilizing connection 14 is arranged on the underside of the tabletop 2, which additionally connects the tabletop 2 to the base 3. A beam 12 of the stabilizing connection 14 is arranged at a distance from the tabletop 2 and extends along the transverse axis Q essentially over the entire width of the tabletop 2. It is guided through an opening 13 of the base 3, in this embodiment through the cantilever arm of the substructure 7. The opening 13 has a height h along the vertical axis H, which is matched to the height of the beam 12. This means that the beam 12 is inhibited in its movement in the direction of the vertical axis H by the opening 13 and the tabletop 2 can no longer be moved along this axis or can no longer tilt about the longitudinal axis L or transverse axis Q. The beam 12 stabilizes the tabletop 2 in the plane which is spanned by the transverse axis Q and longitudinal axis L and which is normal to the vertical axis H.

The opening 13 is considerably wider than the width of the beam 12 and therefore allows the tabletop 2 to rotate in the plane relative to the base 3. In addition, the beam 12 is movable along the longitudinal axis L in the opening 13. In this way, the stabilizing connection 14 gives the tabletop stability along the vertical axis H, but does not hinder its movement along the transverse axis Q or its rotation about the vertical axis H.

1. A table for a vehicle, comprising: at least one base for attachment to the vehicle and a tabletop connected to the base, and wherein the tabletop is moveable in relation to the base along a transverse axis of the table transversely to a longitudinal axis of the table, wherein the tabletop and the base are connected to each other via at least two connection systems and wherein each connection system includes a guided connection between the tabletop and the base via two mutually interacting guide elements, wherein the guide elements are configured such that during a movement along the transverse axis, a force transfer takes place between the guide elements, wherein for each connection system a first guide element is immovably connected to the tabletop along the transverse axis, and a second guide element is immovably connected to the base along the transverse axis, and in at least one guide element of at least one connection system is movably connected along the longitudinal axis to the element to which it is immovably connected along the transverse axis.

2. The table according to claim 1, wherein the force transfer between the guide elements includes a plastic deformation of at least one of these parts or friction between the guide elements.

3. The table according to claim 1, wherein a guide element of at least one connection system defines a slotted hole, which has a smaller width than the guide element guided by it, and in the other guide element is designed as a pin, which is arranged in the slotted hole and is guided thereby.

4. The table according to claim 3, wherein the slotted hole has a receiving region with an enlarged cross-section, in which the pin is arranged in an initial position of the tabletop relative to the base, wherein the cross-section of the receiving region is adapted to the shape and size of the pin.

5. The table according to claim 3, wherein the slotted hole tapers in at least one direction, at least in sections, from a receiving region in which the pin is arranged in an initial position of the tabletop relative to the base.

6. The table according to claim 1, wherein the connection systems are arranged along the longitudinal axis of the table or the slotted hole of at least one connection system extends along the transverse axis.

7. The table according to claim 3, wherein the slotted hole of at least one connection system is arranged in a guide plate and guide plate of at least one connection system, is either immovably connected to the base along the transverse axis and movably connected along the longitudinal axis or is immovably connected to the tabletop along the transverse axis and movably connected along the longitudinal axis.

8. The table according to claim 7, wherein the guide plate has several layers and the slotted hole in at least one layer has a different cross-section, at least in sections, than the slotted hole of another layer or the slotted hole in at least one layer projects at least in sections beyond the slotted hole of another layer.

9. The table according to claim 1, the tabletop is connected to the base via a stabilizing connection, wherein the stabilizing connection limits the movement of the tabletop in relation to the base to a plane which is spanned by the longitudinal axis and transverse axis.

10. The table according to claim 9, wherein the stabilizing connection further comprises a beam connected to the tabletop at least in a vertical axis transverse to the longitudinal axis and to the transverse axis, and wherein the beam is guided in an opening of the base which prevents the beam from pivoting about the longitudinal axis.

11. The table according to claim 1, wherein the table has at least one elastically deformable secondary element which is connected between the tabletop and the base and is arranged in the beam.

12. The table according to claim 11, wherein the elastically deformable secondary element pretensions the tabletop into an initial position in relation to the base.

13. The table according to claim 1, wherein the table has a substructure firmly connected to the base, that the substructure preferably has at least one table leg which can be connected to a vehicle floor.

14. The table according to claim 1, wherein the base can be connected to a vehicle wall of the vehicle.
